(19) United States
(12) Patent Application Publication
(10) Pub. No.: US 2010/0203857 A1
(43) Pub. Date: Aug. 12, 2010

(54) RADIO RECEIVER

(75) Inventors: Tadahiro Makabe, Gunma-ken (JP); Satoshi Terada, Paramus, NJ (US); Masaki Kinoshita, Ridgewood, NJ (US)

Correspondence Address: OSHA LIANG L.L.P., TWO HOUSTON CENTER, 909 FANNIN, SUITE 3500, HOUSTON, TX, 77010, US

(73) Assignees: Sanyo Electric Co., Ltd., Osaka (JP); Sanyo Semiconductor Co., Ltd., Ora-Gun (JP)

(21) Appl. No.: 12/369,365

(22) Filed: Feb. 11, 2009

(51) Int. Cl. H04B 1/18

(52) U.S. Cl. 455/185.1

(57) ABSTRACT

Current position information is acquired based on input by an inputting unit. A broadcasting station memory stores, for each region and for each genre, data regarding a frequency of an existing broadcasting station. A reception frequency is determined based on the current position information and on the frequency of the broadcasting station for each genre at the current position acquired referring to the data of the broadcasting station memory.

### BACKGROUND OF THE INVENTION

1. Field of the Invention

The present invention relates to a radio receiver which receives a broadcasting wave from a broadcasting station.

2. Description of the Related Art

A radio broadcast is transmitted from radio broadcasting stations of each region. A radio receiver receives the broadcast wave and replays a sound signal. The broadcast wave is provided at a predetermined frequency interval in a predetermined frequency band. In an FM broadcast, for example, broadcasting stations can exist at every 100 kHz in Japan and every 50 kHz in the United States, and are distributed in the frequency band of the broadcast wave in a range of approximately 15 MHz to 20 MHz.

Whether or not a broadcast wave exists at a particular frequency depends on the region. Because of this, it is sequentially checked whether or not there is a broadcasting station at a corresponding frequency through an automatic search function or the like, and when a broadcasting station is present, the received wave is replayed so that a desired broadcasting station can be selected. If the radio receiver is in the same region, the frequencies of the broadcasting stations of that region can be registered and a frequency can be selected from the registered frequencies. However, in a radio equipped on a vehicle, the broadcasting stations that can be received may change during a long-distance movement. In such a case, it is necessary to search for broadcasting stations of that region through the above-described automatic search function or the like, and select the received broadcast wave of the radio receiver.

JP 2005-286711 A, etc. disclose searching of the broadcasting station.

The selection of the broadcasting station by a user is executed based on the contents of the broadcast (program). If the user checks the broadcast program with newspaper or the Internet in advance, no problem arises in selection of the broadcasting station. However, when the user does not have information of the program, the user must select the broadcasting stations in order with the automatic search function or the like and check the broadcast programs.

In cases where there are a very large number of FM broadcasting stations, such as in the United States, the checking of the broadcasting stations in order and finding the desired broadcasting station have been operations that require a long period of time.

### SUMMARY OF THE INVENTION

According to one aspect of the present invention, a broadcasting station memory is provided and presence of the broadcasting station for each region and each genre is stored in the broadcasting station memory. Therefore, a broadcasting station can be efficiently selected according to the preferences of the user with the use of the broadcasting station memory.

### BRIEF DESCRIPTION OF THE DRAWINGS

A preferred embodiment of the present invention will be described in detail with reference to the drawings, wherein:

FIG. 1 is a diagram showing a structure of a radio receiver according to a preferred embodiment of the present invention; and

FIG. 2 is a diagram showing a structure of a broadcasting station memory.

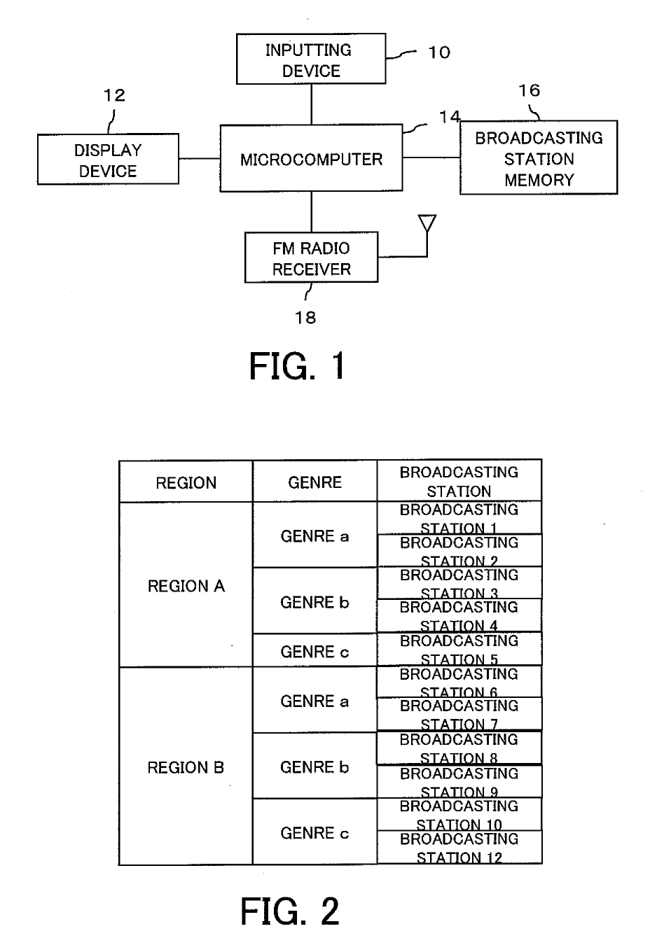

### DESCRIPTION OF THE PREFERRED EMBODIMENT

A preferred embodiment of the present invention will now be described with reference to the drawing.

An inputting device 10 functions as an inputting unit for various inputs. The inputting device 10 functions as an inputting device of a genre desired by the user or the like and also as a current position inputting device. For example, the inputting device 10 may be formed with a numerical pad or the like and a zip code, a phone number (area code), etc. may be input. Alternatively, the name of the city or an address may be directly input. Alternatively, it is also possible to form the inputting device 10 with a GPS device or the like and detect the current position. The GPS device detects the current position by receiving electric waves from a plurality of artificial satellites and is equipped in various devices. In addition, in many cases, an automobile is equipped with a navigation device, and in such cases, the current position is detected with the GPS device or various communication devices. Thus, the current position information may be acquired from the navigation device. In addition, if the inputting device 10 is formed with a voice recognition device, the name of the city or the like can be input with voice. Moreover, in the present embodiment, a display device 12 is provided. It is therefore possible to form the inputting device 10 with a touch panel on a front surface of the display device 12. In a touch panel, the current position can be input in various manners such as, for example, selection from a map display. Moreover, with the touch panel, the inputting of Yes and No and the inputting of the text and numbers may be executed by selection on the screen.

The inputting device 10 and the display device 12 are connected to a microcomputer 14. The microcomputer 14 executes various processes in addition to processing of input data from the inputting device 10.

A broadcasting station memory 16 is connected to the microcomputer 14. As shown in FIG. 2, the broadcasting station memory 16 stores, for each region and for each genre, data regarding broadcasting frequency of the existing broadcasting station. More specifically, as described above, the broadcasting stations avoid interference by using only the predetermined frequency in every 100 kHz or every 50 kHz. Thus, the frequencies at which the broadcasting stations which can be received exist differ depending on the region. Moreover, the broadcasting stations can be classified into various genres such as broadcasting stations that only broadcast news, broadcasting stations that only broadcast weather forecasts, broadcasting stations that broadcast music (may be further classified by genres such as popular, classical, jazz, etc.), broadcasting stations that broadcast comprehensively, etc. The broadcasting station memory 16 in the present embodiment stores the broadcasting stations of each region classified in genres.

The microcomputer 14 identifies the region according to current position data from the inputting device 10 and reads the broadcasting frequencies from the broadcasting station memory 16, so that the frequency of the broadcasting station which can be used at the current position can be identified. The genre may include the data of the broadcasting stations of the same affiliation. That is, there may be cases where the broadcasting stations themselves differ because the regions differ, but the same contents are broadcasted. It is preferable that this data also be stored in the broadcasting station memory as data of genre.

An FM radio receiver 18 is connected to the microcomputer 14. The FM radio receiver 18 is a typical FM radio, and receives a broadcasting wave of a particular frequency and outputs the received signal from the speaker as a sound. The FM reception frequency is controlled by a signal from the microcomputer 14. The connection between the microcomputer 14 and the FM radio receiver 18 is preferably achieved with a serial bus such as the 12C bus.

When, for example, the FM radio receiver 18 is switched ON during running of an automobile or the like, the microcomputer 14 recognizes the current position based on a signal from the inputting device 10, and displays, on the display device 12, the genre, name of broadcasting station, and broadcasting frequency in which the corresponding broadcasting stations exist. The recognition of the current position may be achieved by various methods as described above.

Therefore, the user can check the preferred genre and select the broadcasting station. For example, by looking at the broadcasting station frequency and selecting a tuning frequency for the FM radio receiver 18, the user can select the broadcasting station. Alternatively, the inputting device 10 formed with a touch panel may be used for selecting the broadcasting station while the user looks at the broadcasting station displayed on the display device 12. When the number of broadcasting stations is large, it is also preferable to display the broadcasting station after accepting the selection of the genre.

When the region in which the user is listening to the FM broadcasting changes due to movement by automobile or the like, the microcomputer 14 displays on the display device 12 a selecting screen of a next broadcasting station, along with information that the region has been changed. During this process, it is preferable that only the broadcasting stations of the same genre be displayed. With such a configuration, the user can more easily select the broadcasting station of the same genre. It is also possible to determine, in advance, the broadcasting stations of the same affiliation and the broadcasting stations of the same genre, and ask for the user's agreement to select the broadcasting station. In this case, the user can input with the Yes button on the touch panel or by speaking the word “Yes” using the voice recognition for selection, and the station can be selected in a more efficient manner. Alternatively, it is also possible to provide various information to the user from the speaker in place of the display device, employ a voice recognition device as the inputting device, and input the user's instructions through voice input.

The broadcasting station memory 16 stores data of broadcasting frequency for each region and each genre. For example, in the United States, these data are publicized, and thus the publicized data may be stored. It is preferable that the broadcasting station memory 16 be formed with a flash memory or the like and the data be stored in the broadcasting station memory 16 at the factory before shipping.

It is also preferable that a number of selection by the user be stored for each broadcasting station and be used for determining the priority of display of the broadcasting stations or genres.

What is claimed is:

1. A radio receiver comprising:
an inputting unit which inputs a preferred genre;
a broadcasting station memory which stores, for each genre, a broadcasting frequency of a corresponding broadcasting station; and
a broadcasting station identifying unit which identifies a broadcasting station according to data in the broadcasting station memory based on a genre input by the inputting device, wherein
a broadcast wave from a broadcasting station identified by the broadcasting station identifying unit is received.

2. The radio receiver according to claim 1, wherein
the broadcasting station memory stores, for each region, a broadcasting frequency of a broadcasting station corresponding to each genre, and
a broadcast wave from a broadcasting station of the corresponding genre at a current position is received according to current position information.

3. The radio receiver according to claim 2, wherein
the current position information is determined by data from a GPS receiver.

4. The radio receiver according to claim 2, wherein
the current position information is determined based on data which is input from the inputting unit.
